(19) United States
(12) Patent Application Publication
(10) Pub. No.: US 2008/0175156 A1
(43) Pub. Date: Jul. 24, 2008

(54) METHOD FOR OPERATION AND MONITORING OF MPLS NETWORKS

(75) Inventor: Joachim Klink, Muenchen (DE)

Correspondence Address: BELL, BOYD & LLOYD, LLP, P.O. BOX 1135, CHICAGO, IL, 60690, US

(73) Assignee: Siemens Aktiengesellschaft, Muenchen (DE)

(21) Appl. No.: 12/054,958

(22) Filed: Mar. 25, 2008

Related U.S. Application Data
(63) Continuation of application No. 10/509,360, filed on Sep. 24, 2004.

(30) Foreign Application Priority Data
Mar. 27, 2002 (DE) 10213871.0

(51) Int. Cl. H04L 12/26; H04L 12/56

(52) U.S. Cl. 370/241.1; 370/389

(57) ABSTRACT

The invention relates to a manner of integrating an OAM functionality into an MPLS network with little cost within MPLS networks. MPLS-OAM packets are thus provided. The above are added to the stream of useful data packets and are differentiated from the MPLS packets by means of a particular marking or code provided within the packet header.

### CROSS REFERENCE TO RELATED APPLICATIONS

This application is the US National Stage of International Application No. PCT/DE03/00894, filed Mar. 18, 2003 and claims the benefit thereof. The International Application claims the benefits of German application No. 10213871.0 filed Mar. 27, 2002, both of the applications are incorporated by reference herein in their entirety.

### FIELD OF INVENTION

The invention relates to a method for operating and monitoring MPLS networks.

### BACKGROUND OF INVENTION

In the prior art, OAM (Operation and Maintenance) functionality is to be viewed as a major component of operation of public communication networks. It supports the quality of the network performance while simultaneously reducing the operating costs of the network. It makes a significant contribution in particular as regards the quality of the information transmitted (Quality of Service, QoS). Strategies as regards OAM functionalities have already been proposed for SONET/SDH and for ATM networks.

The OAM functionality enables the operator of a communication network to obtain information at any time about whether the Service Level Agreement guaranteed for a connection is actually being met. To do this the operator must also know the availability of existing connections (connection “up” or “down”) and the delay in transferring the information (delay, delay variation), the—where necessary averaged—deviation from the otherwise normal gap between two information transmissions (delay jitter), or the number of items of information not allowed to be transmitted at all (blocking rate, error performance).

If for example a connection fails, the fault must be able to be determined immediately (fault detection), localized (fault localization) and where necessary the connection diverted to a standby link (protection switching). This allows the traffic flow in the network and also the billing procedures to be improved.

MPLS networks are currently proposed for transmissions in the Internet. In MPLS (Multiprotocol Packet Label Switching) networks information is transmitted by means of MPLS packets. MPLS packets are variable in length and each have a header and also an information part. The header is used to accommodate connection information while the information part is used to hold payload information. IP packets are used as payload information. The connection information contained in the header part is embodied as an MPLS connection number. However this is only valid in the MPLS network. If an IP packet from an Internet network enters the MPLS network with this (FIG. 1), it is prefixed with the header valid in the MPLS network. This contains all connection information which specifies the path of the MPLS packet in the MPLS network. If the MPLS packet leaves the MPLS network the header is removed again and the IP is routed onwards in the connecting Internet network as defined in the IP protocol.

FIG. 1 assumes that information is for example routed to a subscriber TLN2 starting from a subscriber TLN1. The sending subscriber TLN1 is connected in this case to the Internet network IP, through which the information is routed in accordance with an Internet protocol such as the IP protocol. This protocol is not a connection-oriented protocol. The Internet network IP features a plurality of routers R which can be intermeshed. The receiving subscriber TLN2 is connected to a further Internet network IP. Between the two Internet networks IP an MPLS network is inserted through which information in the form of MPLS packet is switched connection-oriented. This network features a plurality of intermeshed routers. In an MPLS network these can be what are known as Label Switched Routers (LSR).

The OAM functionality relating to an MPLS network has not previously been addressed. It can also not just simply be transferred from the solution for ATM networks.

### SUMMARY OF INVENTION

The object of the invention is to demonstrate a method by which OAM functionality can be integrated into MPLS networks at low cost.

The object of the invention is achieved by the claims.

A particular advantage of the invention is the provision of MPLS OAM packets. These are inserted into the traffic stream of the payload data packets. This merely requires a marking or an identification in the packet header so that the MPLS OAM packets can be distinguished from the MPLS packets carrying payload data.

Advantageous developments of the invention are specified in the dependent claims.

The invention is explained in more detail below on the basis of an exemplary embodiment.

### BRIEF DESCRIPTION OF THE DRAWINGS

The Figures show:

FIG. 1 the basic circumstances in an MPLS network

FIG. 2 an end-to-end connection between two subscribers

FIG. 3 the circumstances in the packet header and in the information part of an MPLS OAM packet

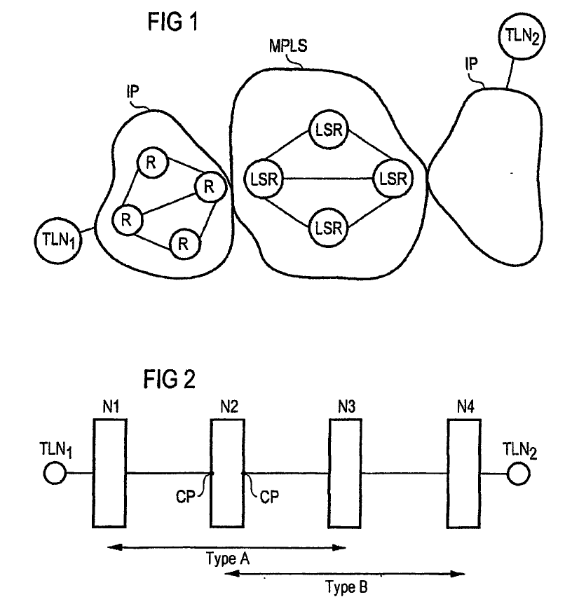

### DETAILED DESCRIPTION OF INVENTION

FIG. 2 illustrates a Label Switched Path (LSP) between two subscribers TLN1, TLN2. This path is routed via a number of nodes N1 . . . N4, by which a plurality of Label Switched Hops are defined. The nodes N1 . . . N4 should be embodied as Label Switched Routers LSR of an MPLS network. After the Label Switched Path has been successfully established there is now a flow of information between the subscriber TLN1 and the subscriber TLN2 which is made up of a plurality of MPLS packets carrying payload data. MPLS OAM packets (inband LSP) can be inserted into this MPLS packet flow. By contrast connections are defined via which exclusively MPLS OAM packets are routed (outband LSP). Basically inband MPLS OAM packets are useful to log a label switched path LSP on an individual basis. In a few cases however it can be more advantageous to define an out-of-band MPLS-OAM packet flow. An example of this is MPLS Group Protection switching.

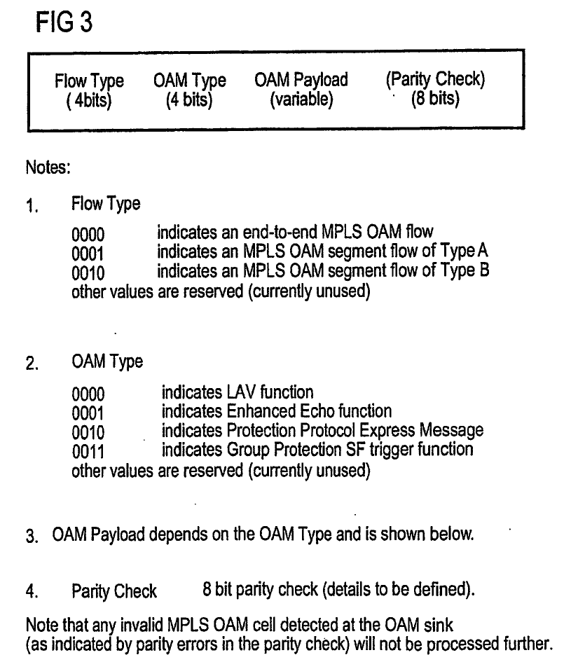

To enable MPLS OAM Packets to be distinguished from MPLS packets carrying payload data the MPLS OAM packets are marked. The specific marking mechanisms are illustrated in FIG. 3 and will be described in greater detail individually later in this document.

The sequence of a number of MPLS OAM packets defines an MPLS OAM packet flow. Basically three different types of MPLS OAM packet flow can exist simultaneously for a Label Switched Path LSP:

End-to-end MPLS OAM packet flow. This is used especially if there is an OAM communication between a source and a sink of a Label Switched Path LSP. It is made up of MPLS OAM packets which are inserted into the payload data stream at the source of the Label Switched Path LSP and removed again at the sink of this path. The MPLS OAM packets can be recorded and monitored along the Label Switched Path LSP at the Connection Point CP without intervention into the transmission process.

The Type-A MPLS OAM packet flow is distinguished from the end-to-end defined MPLS OAM packet flow. It is used in particular when there is OAM communication between the nodes which delimit a segment of Type A (FIG. 2). One or more MPLS OAM segments of Type A can be defined in the Label Switched Path LSP, but they can neither be nested nor can they overlap with other Type-A segments.

Finally the MPLS OAM Type-B packet flow is distinguished from the two types of packet flow given here. It is used especially if there is an OAM communication between the nodes which delimit a Type-B segment (FIG. 2). One or more MPLS OAM segments of Type B can be defined in the Label Switched Path LSP, but they can neither be nested nor can they overlap with other Type-B segments.

Basically an MPLS OAM packet flow (end-to-end, Type A, Type B) is made up of MPLS OAM packets which are inserted into the payload data stream at the start of a segment and removed from it again at the end of a segment. They can be recorded and processed along the Label Switched Path at the Connection Points CP without any intervention into the transmission process. Each Connection point CP in the Label Switched Path LSP, including the sources and sinks of the path, can be configured as MPLS-OAM source or MPLS-OAM sink, in which case outgoing MPLS OAM packets from an MPLS OAM source are preferably to be configured as “upstream”.

Before MPLS-OAM packets (end-to-end, Type A, Type B) are transferred via the MPLS network, the endpoints of the associated MPLS OAM segment must be defined. The definition of source and sink for an MPLS OAM segment is not necessarily fixed for the duration of an LSP. This means that the segment involved can be reconfigured for example via fields in the signaling protocol.

For each Label Switched Path LSP nesting of the segmented MPLS OAM packet flow (Type A or Type B) within an end-to-end MPLS OAM packet flow is possible. The Connection points CP can in this case simultaneously be source/sink of a segment flow (Type A or Type B) and also the end-to-end MPLS OAM packet flow.

The MPLS-OAM Type-A packet flow (segment flow) is functionally independent of the type-B packet flow in relation to insertion, removal as well as processing of the MPLS OAM packets. In general the nesting of MPLS OAM packets of Type B is thus possible with those of Type A and vice-versa. In the case of the nesting a Connection point CP can thus also simultaneously be a source and a sink of an Type-A and Type-B OAM segment flow.

Depending on the network architecture, it is possible for Type-A segments to overlap with Type-B segments. For example in the case of point-to-point architecture segments of Type A can overlap with those of Type B. Both segments can operate independently of each other and will thus not have any effect on each other. In MPLS-protection switching however the overlapping can lead to problems.

A more detailed explanation is given below on the basis of FIG. 3 as to how MPLS OAM packets can be distinguished from MPLS packets bearing payload data. Two alternative approaches are possible here:

In a first embodiment of the invention one of the EXP (experimental) bits can be used in the MPLS packet header to distinguish MPLS OAM packets from MPLS packets carrying payload data. This procedure in particular provides a very simple method of distinguishing the packets. This bit can be checked in the sink of an MPLS OAM segment or at the Connection Points CP to filter out MPLS OAM packets before further evaluations are undertaken.

In a further embodiment of the invention one of the MPLS label values No. 4 to No. 15 can be used in the header of the MPLS Packet as a marker. These MPLS label values were reserved by the IANA. In this case the next label value in the stack must point to the assigned Label Switched Path LSP for which the inband OAM functionality is executed. This approach to a solution is somewhat more complex to implement since the hardware in the OAM sink and the Connection points CP needs two MPLS stack inputs for each MPLS OAM packet. Naturally processing must take place in real time, i.e. in the Connection Points CP the OAM packets must be inserted back into the flow while retaining the sequence. This is absolutely necessary to ensure correct performance monitoring results in the OAM sink.

The MPLS OAM packets contain fields which are just as common to all types of OAM packet as the function fields. The coding principles for the currently unused common and special fields are as follows:
currently unused OAM payload data bytes which are coded as 0110 1010 (6AH)
currently unused payload data bits (incomplete bytes which are coded to zero.

The bytes and bits not currently used should not be checked in the OAM sink for compliance with the coding rule.

Further expansions to MPLS OAM functionality should ensure that devices that support older versions have no compatibility problems as regards the content of the MPLS OAM packets. This means that functions and encodings of defined fields should not be redefined in the future. However presently unused fields and code points can be redefined in the future and are thus reserved. It should also be pointed out that in the exemplary embodiment the left bit is the highest-value bit and is transmitted first. The coding for MPLS OAM packets is illustrated in FIG. 3.

1.-12. (canceled)

13. A method for transmitting variable-length packets over connections which are established between communication devices of a communication system, the method comprising:
providing a marker within the header of a packet, wherein the marker identifies a subset of total number of packets transmitted per connection which are used for operating and/or maintaining the network, wherein
the communication devices to form a network.

14. The method according to claim 13, wherein the packets are transmitted in accordance with a Multi Protocol Label Switching (MPLS) transmission procedure, wherein these packets being defined as MPLS packets, and wherein the MPLS packets with the marker are defined as MPLS-OAM (operating and maintenance) packets.

15. The method according to claim 13, wherein one of the EXP bits in the header of the MPLS packet is used as the marker.

16. The method according to claim 14, wherein one of the EXP bits in the header of the MPLS packet is used as the marker.

17. The method according to claim 13, wherein one of the reserved MPLS label values No. 4 to No. 15 is used in the header of the MPLS packet as the marker.

18. The method according to claim 14, wherein one of the reserved MPLS label values No. 4 to No. 15 is used in the header of the MPLS packet as the marker.

19. The method according to claim 13, wherein
an end-to-end MPLS-OAM packet flow is formed from the MPLS-OAM packets which is transmitted between source and sink of the connection, wherein
the entire connection is monitored.

20. The method according to claim 14, wherein
an end-to-end MPLS-OAM packet flow is formed from the MPLS-OAM packets which is transmitted between source and sink of the connection, wherein
the entire connection is monitored.

21. The method according to claim 15, wherein
an end-to-end MPLS-OAM packet flow is formed from the MPLS-OAM packets which is transmitted between source and sink of the connection, wherein
the entire connection is monitored.

22. The method according to claim 13, wherein
the connection is formed from a plurality of segments, wherein
an MPLS-OAM segment flow is formed from the MPLS-OAM packets which is transmitted within the segment of the connection concerned between source and sink of the segment, and wherein this segment of the connection is monitored.

23. The method according to claim 14, wherein
the connection is formed from a plurality of segments, wherein
an MPLS-OAM segment flow is formed from the MPLS-OAM packets, wherein the MPLS-OAM segment flow is transmitted, within the segment of the connection, between source and sink of the segment, and wherein this segment of the connection is monitored.

24. The method according to claim 22, wherein different variants of an MPLS-OAM segment flow exist which are defined as Type A, Type B etc. and which can be set up to be functionally independent of each other for the same connection.

25. The method according to claim 19, wherein only one MPLS-OAM segment flow of the same, but a number of MPLS-OAM segment flows of different variants can be simultaneously created for any given segment of the connection.

26. The method according to claim 13, further comprising:
providing a second marker within an MPLS-OAM packet to indicate whether the MPLS-OAM packet is part of an end-to-end MPLS-OAM packet flow or part of an MPLS-OAM segment flow.

27. The method according to claim 14, further comprising:
providing a second marker within an MPLS-OAM packet to indicate whether the associated MPLS-OAM packet is part of an end-to-end MPLS-OAM packet flow or part of an MPLS-OAM segment flow.

28. The method according to claim 13, further comprising:
providing a third marker within an MPLS OAM packet to indicate the variant of the MPLS-OAM segment of the MPLS-OAM packet.

29. The method according to claim 13, further comprising:
providing a fourth marker within an MPLS-OAM packet which identifies the functional significance of the MPLS-OAM packet in greater detail.

30. The method according to claim 13, further comprising:
transmitting further information within an MPLS-OAM packet, wherein this information is used to support operation and maintenance of the network.
